(19) United States
(12) Patent Application Publication
(10) Pub. No.: US 2012/0271441 A1
(43) Pub. Date: Oct. 25, 2012

(54) PORTABLE ELECTRONIC DEVICE

(75) Inventors: JU-YUAN ZHANG, Shenzhen City (CN); HUA-LIN LIU, Shenzhen City (CN); ZHANG-YONG ZHENG, Shenzhen City (CN); XUE-SHUN LIU, Shenzhen City (CN); BI-QING LUO, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/207,453

(22) Filed: Aug. 11, 2011

(30) Foreign Application Priority Data
Apr. 25, 2011 (CN) 201110103543.2

(51) Int. Cl. G06F 17/00

(52) U.S. Cl. 700/94

(57) ABSTRACT

A portable electronic device includes an input unit, an audio processing unit, a low pass filter, and at least one vibrator. The input unit is configured to generate operation signals in response to user inputs. The audio processing unit is configured to retrieve an audio file when an operation signal from the input unit for playing the audio file is received, decode the audio file, and convert the decoded audio file to analog audio signals. The low pass filter is configured to transmit analog audio signals with heavy bass to at least one vibrator. The at least one vibrator is configured to create physical vibration in response to the analog audio signals with heavy bass to physical vibration.

### BACKGROUND

1. Technical Field

The present disclosure relates to portable electronic devices, and particularly to a portable electronic device with body-sensing vibration function.

2. Description of Related Art

Although portable electronic devices with music playing function such as an iPhone, or an ipod are common, they do not have the function of converting audio signals of music files to rhythmic physical vibration.

Therefore, what is needed is a portable electronic device with body sensing vibration function to overcome the limitations described above.

### BRIEF DESCRIPTION OF THE DRAWINGS

The components in the drawings are not necessarily drawn to scale, the emphasis instead being placed upon clearly illustrating the principles of a portable electronic device with body-sensing vibration function. Moreover, in the drawings, like reference numerals designate corresponding sections throughout the several views.

FIG. 1 is a schematic view of a user using a portable electronic device in accordance with an exemplary embodiment.

FIG. 2 is a block diagram of the portable electronic device of FIG. 1.

### DETAILED DESCRIPTION

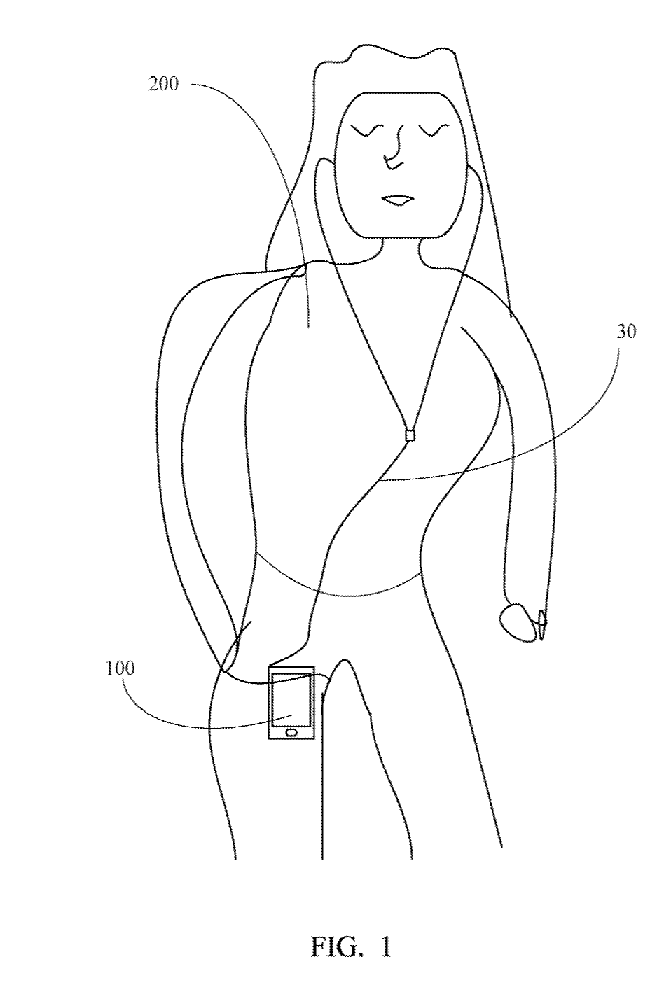

Referring to FIG. 1, a schematic view of a user 200 using a portable electronic device 100 in accordance with an exemplary embodiment is disclosed. The user 200 wears the electronic device 100 on the waist. In the embodiment, the electronic device 100 is a mobile phone. In another embodiment, the electronic device 100 can be any other type of electronic devices with music playing function, such as a digital photo frame, a digital personal assistant, or a media player. The user 200 can wear the electronic device 100 on any other body parts.

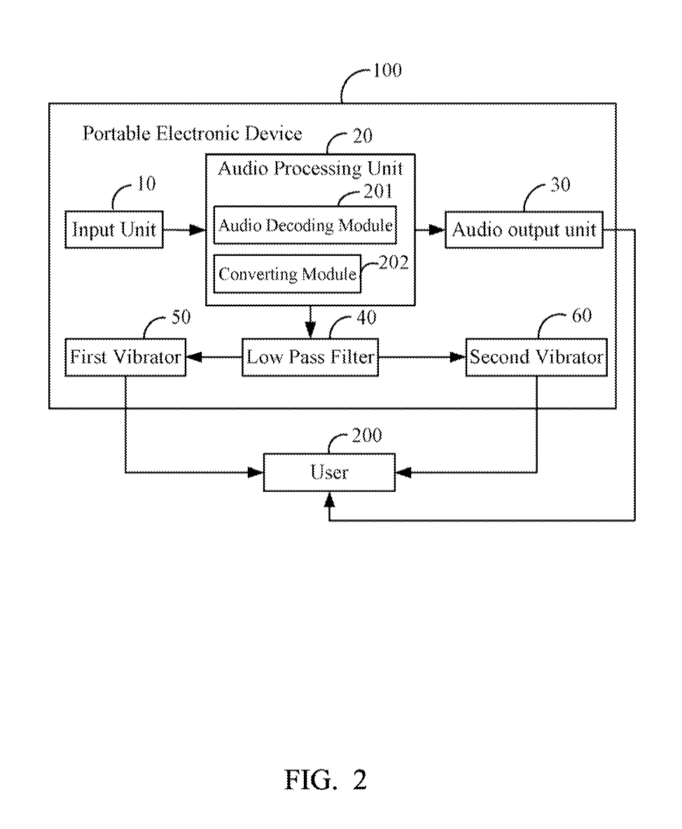

Referring to FIG. 2, the electronic device 100 includes an input unit 10, an audio processing unit 20, an audio output unit 30, a low pass filter 40, a first vibrator 50, and a second vibrator 60. In the embodiment, the audio output unit 30 is earphones. In an alternative embodiment, the electronic device 100 can include only one vibrator or more than two vibrators.

The input unit 10 is configured to generate operation signals in response to user inputs, and transmitting the operation signals to the audio processing unit 20. The user 200 can control the electronic device 100 to play audio files, switch between songs, or adjust the output volume via the input unit 10. In the embodiment, the input unit 10 is a touch input apparatus. In an alternative embodiment, the input unit 10 can be a mechanical key input apparatus including functional keys commonly used.

The audio processing unit 20 is configured to process an audio file according to the operation signals. In the exemplary embodiment, the audio processing unit 20 retrieves an audio file when an operation signal for playing the audio file is received. The audio processing unit 20 includes an audio decoding module 201 configured for decoding the audio file, and a converting module 202 configured for converting the decoded audio file to analog audio signals. The audio processing unit 20 further transmits the analog audio signals to the audio output unit 30.

The audio output unit 30 is configured to reproduce the analog audio signals transmitted from the audio processing unit 20.

The audio processing unit 20 also transmits the analog audio signals to the low pass filter 40. The low pass filter 40 is configured to filter out the analog audio signals of the left and right channels with frequencies beyond the range from 16 Hz to 150 Hz, and transmitting the analog audio signals of the left and right channels with frequencies in the range from 16 Hz to 150 Hz to the first and second vibrators 50, 60 respectively. The analog audio signals with frequencies in the range from 16 Hz to 150 Hz are heavy bass.

The first and second vibrators 50, 60 are configured to create physical vibration in response to the audio signals with frequencies in the range from 16 Hz to 150 Hz to rhythmic physical vibration with tens of microns to tens of microns amplitude. That is, the first and second vibrators 50, 60 convert proper analog audio signals to rhythmic physical vibration changing with the played music. In the embodiment, the frequency of the physical vibration resonates with the parasympathetic frequency of human, which brings positive user feelings to the played music.

In use, the electronic device 100 is worn on a certain body part such as waist or wrist of the user. The rhythmic physical vibration generated by the first and second vibrators 50, 60 acts on the body when the electronic device 100 is playing the music, which may bring a sense of relaxation to the user.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A portable electronic device comprising:
an input unit configured to generate operation signals in response to user inputs;
an audio processing unit configured to retrieve an audio file when an operation signal from the input unit for playing the audio file is received, decode the audio file, and convert the decoded audio file to analog audio signals; and
a low pass filter configured to transmit analog audio signals with heavy bass to at least one vibrator; the at least one vibrator configured to create physical vibration in response to the analog audio signals with heavy bass.

2. The portable electronic device as described in claim 1, wherein the analog audio signals with heavy bass comprise analog audio signals with frequencies in the range from 16 Hz to 150 Hz.

3. The portable electronic device as described in claim 2, wherein the at least one vibrator comprises a first vibrator and a second vibrator, and the low pass filter is configured to transmit the analog audio signals of the left and right channels with frequencies in the range from 16 Hz to 150 Hz to the first and second vibrators respectively.

4. The portable electronic device as described in claim 2, wherein the physical vibration comprises tens of microns to tens of microns amplitude.

5. The portable electronic device as described in claim 1, further comprising an audio output unit, the audio output unit being an earphone.

6. The portable electronic device as described in claim 1, the portable electronic device being a mobile phone or a media player.

7. A portable electronic device comprising:
an audio outputting module configured for playing an audio file;
an audio decoding module configured for decoding the audio file;
a converting module configured for converting the decoded audio file into analog audio signals;
a low pass filter configured for filtering out analog audio signals with frequencies greater than 150 Hz and outputting analog audio signals with frequencies in the range from 16 Hz to 150 Hz, and
at least one vibrator configured for creating vibration of portable electronic device in response to the analog audio signals outputted from the low pass filter.

8. The portable electronic device as described in claim 7, wherein the analog audio signals with heavy bass comprise analog audio signals with frequencies in the range from 16 Hz to 150 Hz.

9. The portable electronic device as described in claim 8, wherein the at least one vibrator comprises a first vibrator and a second vibrator, and the low pass filter is configured to transmit the analog audio signals of the left and right channels with frequencies in the range from 16 Hz to 150 Hz to the first and second vibrators respectively.

10. The portable electronic device as described in claim 8, wherein the physical vibration comprises tens of microns to tens of microns amplitude.

11. The portable electronic device as described in claim 7, further comprising an audio output unit, the audio output unit being an earphone.

12. The portable electronic device as described in claim 7, the portable electronic device being a mobile phone or a media player.
